(19) United States
(12) Patent Application Publication
(10) Pub. No.: US 2009/0094614 A1
(43) Pub. Date: Apr. 9, 2009

(54) Direct synchronous input

(75) Inventors: Dmitri Klementiev, Redmond, WA (US); Ian Ellison-Taylor, Vashon, WA (US); Paul Trieu, Kirkland, WA (US); Ross Wolf, Seattle, WA (US); Brendan McKeon, Seattle, WA (US); Moshe Vainer, Redmond, WA (US); Ankur Srivastava, Hyderabad (IN); Shiva Shankar Thangadurai, Hyderabad (IN); Neeraja Reddy, Hyderabad (IN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/973,116

(22) Filed: Oct. 5, 2007

(51) Int. Cl. G06F 3/01

(52) U.S. Cl. 719/310

(57) ABSTRACT

Various technologies and techniques are disclosed for providing direct synchronous input. An input monitor determines where an input from a sender that is directed to a target element is about to be delivered. One example for providing an input monitor includes using a system hook. If the input monitor determines that the input is about to be delivered to the target element, the input is delivered to the target element, and the sender is notified that delivery to the target element succeeded. An interface for providing a direct synchronous input is also described. The interface has a start method for monitoring inputs being sent to target elements from a sender. The interface also has a received event for notifying the sender when a particular input is received by the target element.

### BACKGROUND

Almost, if not all, modern operating systems are multi-threaded. Furthermore, more and more systems allow concurrent applications, each with their own threads, to be running using multi-processors. At the same time, the rise of graphical user interface applications which use the threads, have allowed users to interface with both the operating system and whatever applications may be running on it in an astounding number of ways. For example, multiple applications, each application with multiple windows, can be running simultaneously. The user is presented with an almost unlimited number of paths through the feature sets. Using input devices, such as a mouse or keyboard, the user can impulsively switch from window to window, and treenode to text box.

When testing applications with graphical user interfaces (GUIs), a tester must take both the user-driven nature of GUIs and the many choices offered to the user at any time—the multiple paths problem—into account. However, sometimes such needs are contradictory. For example, one solution to the multiple paths program is to automate the GUI testing. As automated testing programs can be run at computer speed, many more pathways through a GUI can be tested than is reasonable when using human testers. But, computers and humans each have their own strengths, and one thing humans excel at is the ability to discern the difference between a minor hiccup in a program and an actual code bug.

Due to the complex interaction between the many threads running on even a modest GUI application and the interaction between those threads, the operating system threads, and the threads of any other applications running, certain actions may fail not because of any underlying problems with the software, but merely because of timing issues. A human tester will most likely ignore a mouse click that does not select an object, but an automated tester will consider such an event as a failure.

For example, if the keyboard focus changes, keyboard input can end up being delivered to the wrong element, or be ignored altogether. If elements move, mouse input can end up being delivered to the wrong element. These problems are a side effect of how input management works. Input is not processed with a specific target in mind. Rather, input is received from a source without any information indicating what the target element is. A given computer system then determines the target for that input at a later stage, taking keyboard focus, mouse state, system hooks, and other factors into account. In other words, a variety of fluid factors end up determining which target element ends up receiving the input message.

These problems become most noticeable in the world of assisted technologies, including with automated testing applications previously mentioned. When sending input programmatically to a target user interface element, a separate program or process is typically used than the application that is being tested. As noted earlier, this means that there is no guarantee that the input will end up being delivered to the target user interface element for which it was intended. In the case of an automated testing program, this can mean that the test may report that a bug or other problem is present, when the only problem was simply that the input was received by the wrong element due to the various factors noted earlier, and that the actual test path was never really processed.

A similar problem exists in the case of assisted technologies that are used by people with disabilities. An assisted technology program may be provided to a user with low vision to allow that user to execute a script that automates various parts of the user interface for which the user would otherwise be unable to see and navigate. Suppose the automated script fails at one point because a mouse click input was not delivered to an OK button (i.e. not received by the target user interface element). It is extremely difficult for the assisted technology program to determine a next proper course of action because it is unknown whether a program bug was encountered, whether the input was simply not delivered properly, and so on.

### SUMMARY

Various technologies and techniques are disclosed for providing direct synchronous input. An input monitor determines where an input from a sender that is directed to a target element is about to be delivered. One example for providing an input monitor includes using a system hook. If the input monitor determines that the input is about to be delivered to the target element, the input is delivered to the target element, and the sender is notified that delivery to the target element succeeded.

In one implementation, an interface for providing a direct synchronous input is also provided. The interface has a start method for monitoring inputs being sent to target elements from a sender. The interface also has a received event for notifying the sender when a particular input is received by the target element.

In another inplementation, a wait notification process can be performed to wait a pre-determined period of time before determining whether the particular input had an opportunity to reach the target element.

In yet another implementation, combinations of a direct synchronous input process and a wait notification process are provided.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of an input monitoring application of one implementation operating on the computer system of FIG. 1.

FIG. 3 is a high level process flow diagram for one implementation illustrating the stages involved in providing direct synchronous input.

FIG. 4 is a process flow diagram for one implementation illustrating the stages involved in using system hooks for direct synchronous input.

FIG. 5 is a process flow diagram for one implementation illustrating the stages involved in using direct synchronous input with assisted technologies.

FIG. 6 is a process flow diagram for one implementation of the system of FIG. 1 illustrating an exemplary interface that can be implemented by a user interface framework to facilitate direct synchronous input.

FIG. 7 is a process flow diagram for one implementation illustrating the stages involved in using direct synchronous input process of FIG. 4 in combination with a wait notification process.

### DETAILED DESCRIPTION

The technologies and techniques herein may be described in the general context as an application that facilitates direct synchronous input with user interface elements, but the technologies and techniques also serve other purposes in addition to these. In one implementation, one or more of the techniques described herein can be implemented as features within an operating system such as MICROSOFT® WINDOWS® or Linux, or from any other type of program or service that delivers and/or interacts with inputs between threads and/or applications. In another implementation, one or more of these the techniques described herein can be implemented as features within applications that provide assisted technologies.

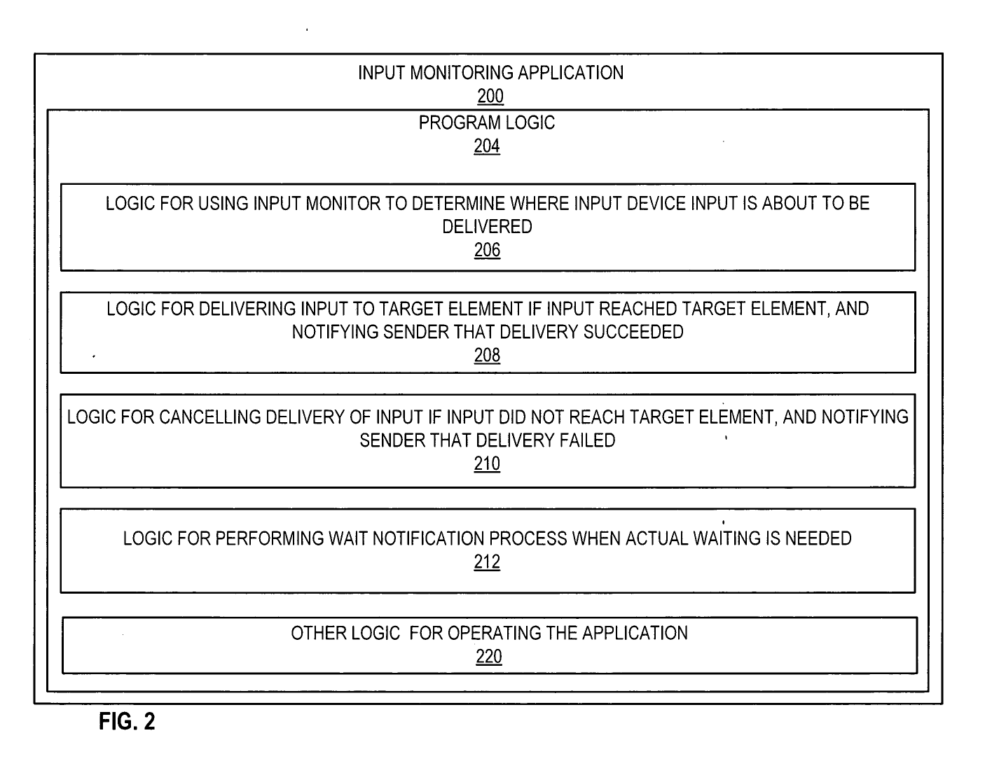

As noted in the background section, graphical user interface automation often produces spurious failures due to synchronization problems with the myriad of threads running at any given time on an operating system. One implementation disclosed herein synchronizes user interface elements directly by using an input monitor to monitor inputs being sent to a target element of interest and then determining whether the input reached the target element. The term “input” as used herein refers to an input that is directed to a target element for which some action should be taken upon receipt. The term “element” as used herein is meant to include any user interface object, such as listboxes, combo boxes, tree structures, radio buttons, calendars, windows, forms, panels, and combinations thereof. New implementations of user interface objects are being constantly created and these examples disclosed also embrace user interface elements that have not specially been named. The term “target element” as used herein is meant to include any of these aforementioned user interface objects defined previously that are an intended recipient of an input. Some aspects of these technologies and techniques are described in further detail in FIGS. 2-6.

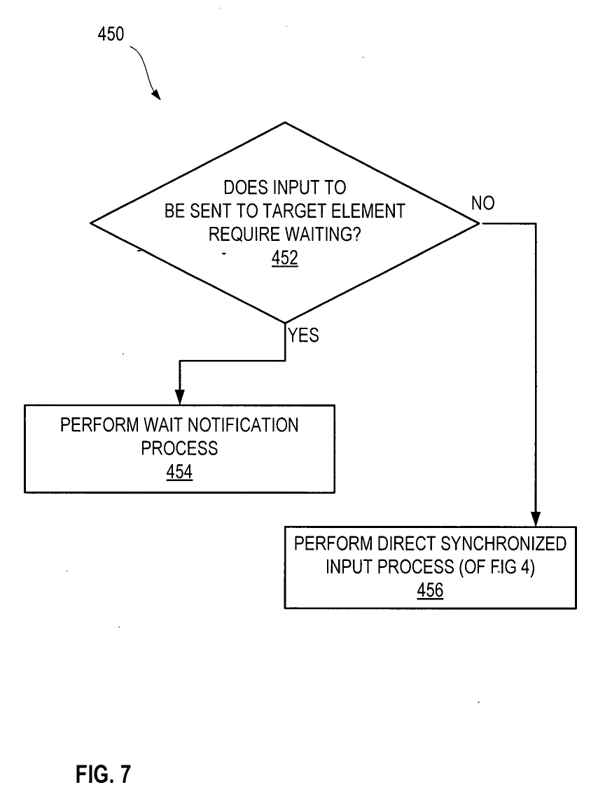

Another implementation disclosed herein utilizes a wait notification process to synchronize user interface elements specifically to ensure that a target element will not fail when attempting to accept user input. Yet another implementation disclosed herein in FIG. 7 uses a combination of these two aforementioned synchronization techniques.

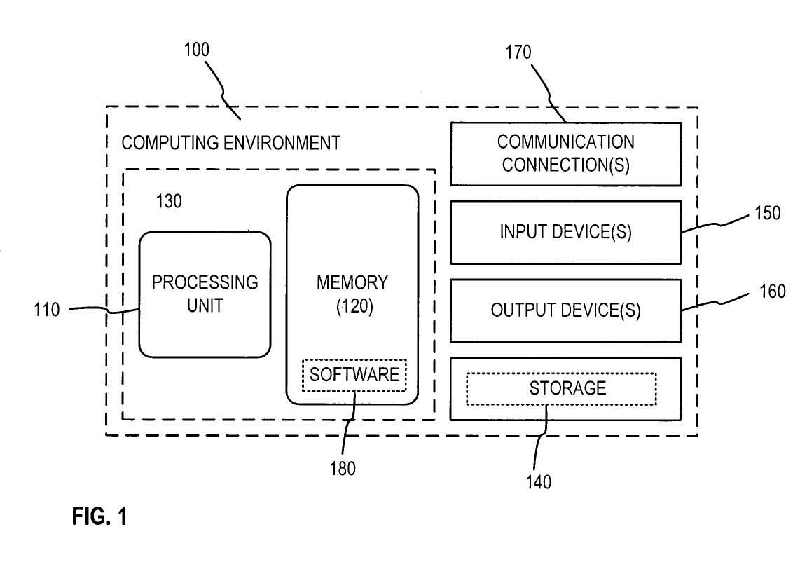

Turning now to FIG. 1, a generalized example of a suitable computing environment 100 is illustrated in which several of the described implementations may be implemented. The computing environment 100 is not intended to suggest any limitation as to scope of use or functionality, as the techniques and tools may be implemented in diverse general-purpose or special-purpose computing environments.

With reference to FIG. 1, the computing environment 100 includes at least one processing unit 110 and memory 120. In FIG. 1, this most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory, etc.), or some combination of the two. The memory 120 stores software 180 implementing a method and system to make a UI element visible.

A computing environment may have additional features. For example, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 140 may be removable or non-removable, and includes magnetic disks, magnetic tapes or cassettes, CD-ROMs, DVDs, or any other medium which can be used to store information and which can be accessed within the computing environment 100. The storage 140 stores instructions for the software 180 implementing the synchronizer.

The input device(s) 150 may be a touch input device such as a keyboard, mouse, pen, trackball, a voice input device, a scanning device, or another device that provides input to the computing environment 100. For audio or video encoding, the input device(s) 150 may be a sound card, video card, TV tuner card, or similar device that accepts audio or video input in analog or digital form, or a CD-ROM or CD-RW that reads audio or video samples into the computing environment 100. The output device(s) 160 may be a display, printer, speaker, CD-writer, or another device that provides output from the computing environment 100.

The communication connection(s) 170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment 100, computer-readable media include memory 100, storage 140, communication media, and combinations of any of the above.

The techniques and tools can be described in the general context of computer-executable instructions, such as those included in program modules, being executed in a computing environment 100 on a target real or virtual processor. Generally, program modules include routines, programs, libraries, objects, classes, components, data structures, etc. that performs particular tasks or implement particular abstract data types. The functionality of the program modules may be combined or split between program modules as desired in various implementations. Computer-executable instructions for program modules may be executed within a local or distributed computing environment.

Turning now to FIG. 2 with continued reference to FIG. 1, an input monitoring application 200 operating on computing device 100 is illustrated. Input monitoring application 200 is one of the application programs that reside on computing device 100. However, it will be understood that input monitoring application 200 can alternatively or additionally be embodied as computer-executable instructions on one or more computers and/or in different variations than shown on FIG. 1. Alternatively or additionally, one or more parts of input monitoring application 200 can be part of system memory 120, on other computers and/or applications, or other such variations as would occur to one in the computer software art.

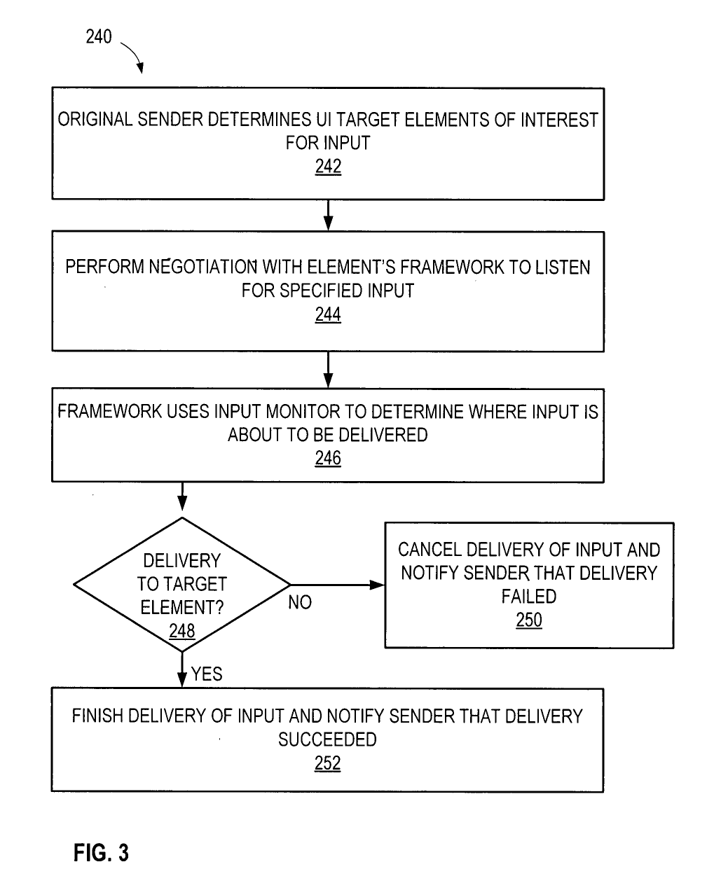

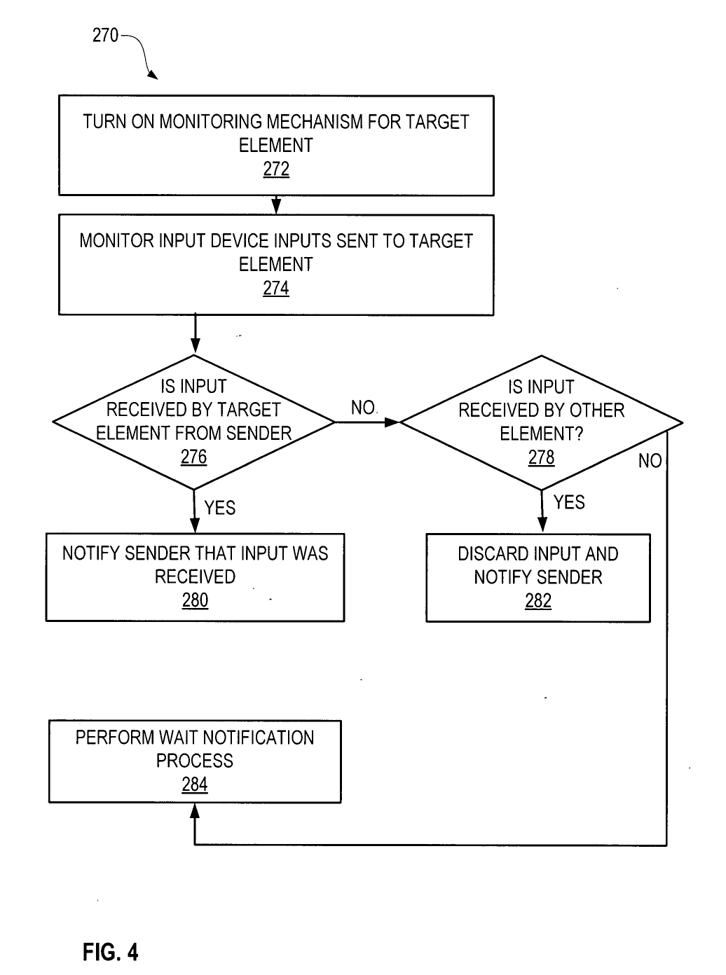

Input monitoring application 200 includes program logic 204, which is responsible for carrying out some or all of the techniques described herein. Program logic 204 includes logic for using an input monitor to determine where an input is about to be delivered 206 (as described below with respect to FIGS. 3-4); logic for delivering an input to an intended target element if the input reached the intended target element, and notifying the input sender that delivery succeeded 208 (as described below with respect to FIGS. 3-4); logic for cancelling delivery of the input if the input did not reach the intended target element, and notifying the sender that delivery failed 210 (as described below with respect to FIGS. 3-4); logic for performing a wait notification process (instead of or in addition to 206, 208, and 210) when actual waiting is needed 212 (as described below with respect to FIG. 7); and other logic 220 for operating the input monitoring application 200.

Turning now to FIGS. 3-6, the stages for implementing one or more implementations of input monitoring application 200 are described in further detail. In some implementations, the processes of FIG. 3-6 are at least partially implemented in the operating logic of computing device 100. FIG. 3 is a process flow diagram illustrating the stages involved in providing direct synchronous input. The term “direct synchronous input” as used herein is meant to include a mechanism that ensures that the input is delivered to the target element. The process begins at start point 240 with an original sender of an input determining the user interface target elements of interest for the input (stage 242). In this context, the sender of the input can be an assisted technology, such as an automated testing program or automated user interface assistance program. The sender performs a negotiation with element's framework to listen for specified input (stage 244). In other words, the sender and the user interface framework agree on a communication protocol for how the user interface framework will monitor input delivery and communicate results back to the sender.

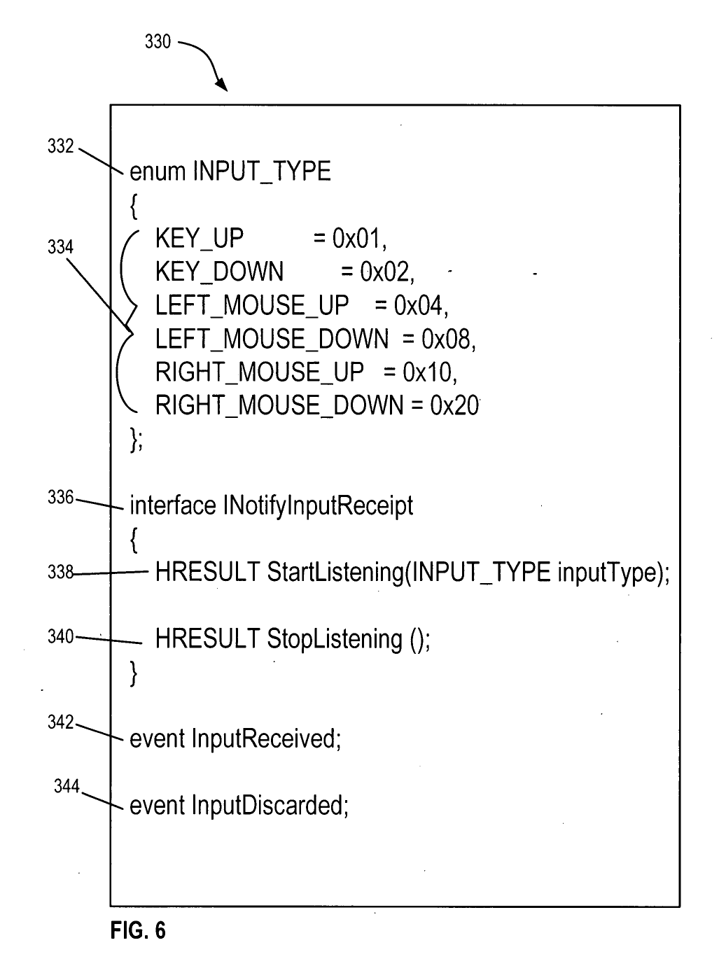

The input is sent, and the framework uses an input monitor to determine to what target element, if any, the input is about to be delivered (stage 246). One implementation of how such monitoring can be provided is described in further detail in FIG. 4. Another implementation of how such monitoring can be provided is illustrated in the exemplary interface shown in FIG. 6. It should be noted that in some implementations, this monitoring can be performed on elements whether or not they have an associated window handle. In some UI technologies, a window handle identifies every UI element and is unique for every UI element. Some elements simply do support a distinct handle to the window. Since the input monitoring is being implemented as an interface specific to a particular UI technology, input sent to target elements that do not have window handles can be intercepted just as well as target elements that do have window handles.

If the input was not delivered to the target element, then delivery of the input is cancelled (i.e. the input is discarded), and the sender is notified that the input delivery failed (stage 250). The sender can then take any suitable action that is proper after failure, such as to re-try sending the input, handle an error, and so on. If the input was delivered to the target element (decision point 248), then finish delivery of the input to the target element and notify the sender that the delivery was successful (stage 252). The sender can then take any suitable action that is proper after success, such as to move on to another interaction with the target UI element, wait for a result generated by the target element in response to processing of the input, and so on. The process ends at end point 254.

Turning now to FIG. 4, one implementation is described for how system hooks can be used to provide the direct synchronous input features described broadly in FIG. 3. The process begins at start point 270 with turning on a monitoring mechanism for a target element (stage 272), such as upon request from a sender to initiate the monitoring for one or more target elements. Again, a sender in this context can be an assisted technology, such as an automated testing program or an automated user interface assistance program. Inputs that are sent to the target element are monitored (stage 274). In one implementation, inputs are monitored using a system hook (stage 274). The term “system hook” as used herein is meant to include a mechanism by which a user-defined function can intercept one or more system inputs before they reach an application. An example of a system hook that could be used to monitor inputs is a WH_GETMESSAGE hook provided by the MICROSOFT® WINDOWS® operating system. In some cases, where using system hooks (e.g. WH_GETMESSAGE) is not sufficient, such as when the target element is an HTML element in a web application (and thus a sub-element of an element accessible by WH_GETMESSAGE), the monitoring can be performed by a combination of the system hook and an additional event handler that is inserted (e.g. programmatically) into the HTML element. This event handler can be written in JavaScript or another suitable language or in any programming language by using an API (e.g. MSHTML) that provides access to the document object model (DOM) and that is designed to listen to the input being sent to the HTML element. Support for different browsers is possible by either using standard cross browser scripting languages, or by using the DOM API provided by the browser. In case of MICROSOFT® Internet Explorer, MSHTML is one such API that is provided. However the approach does not depend on the specific API and therefore is not specific to one particular browser, as long as the browser provides access to the elements.

If the monitoring being performed reveals that the input from the sender was received by the target element (decision point 276), then the sender is notified that the input was received (stage 280). In one implementation, to determine that the input was received by the target element, the system hook procedure can check its window handle parameter (hWND) to determine the actual target window handle and confirm it matches with the target element. The sender can then proceed by taking any action that is appropriate after the input was successfully delivered, such as moving on to another input, waiting for a result that occurs after the target element processes the input, and so on.

However, if the monitoring being performed (such as through a system hook or HTML event handler) reveals that the input from the sender was not received by the target element (decision point 276), but instead the input was received by a different element (decision point 278), then the input is discarded and the sender is notified of the failure (stage 282). If the input was not received by another element (decision point 278), then a wait notification process is performed (stage 284). Note that in some implementations, stage 278 is not present, since it is not always possibly to verify whether or not input was received by another element. In such cases, the input can simply be discarded and/or the wait notification process performed as desired. The wait notification process provides various techniques for waiting a pre-determined period of time and determining whether or not the input had an opportunity to reach the target element. The process ends at end point 286.

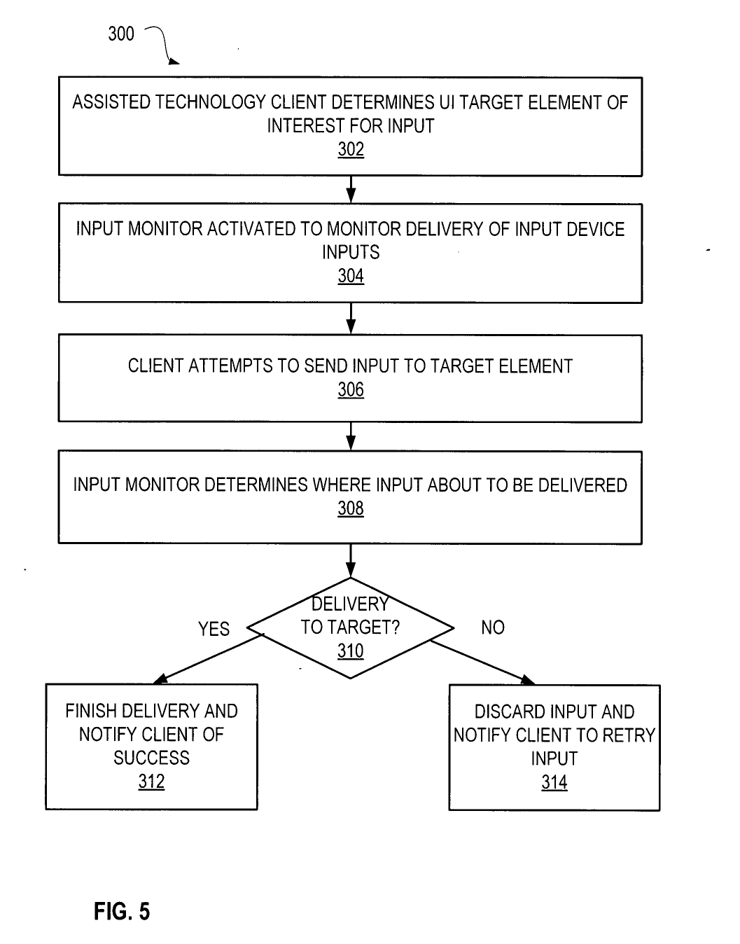

Turning now to FIG. 5, a more specific implementation is described with respect to using direct synchronous input with assisted technologies. This process drills down further into the stages described previously, but with an assisted technology client being specifically mentioned. The process begins at start point 300 with the assisted technology client determining the user interface target element that should receive the input (stage 302). The input monitor is activated to monitor the delivery of inputs (stage 304). The assisted technology client attempts to send an input to the target element (stage 306). The input monitor determines where the input is about to be delivered (stage 308). If the delivery is being made to the target element (decision point 310), then delivery is finished and the client is notified of success (stage 312). If the delivery is not being made to the target (decision point 310), then the input is discarded and the assisted technology client is notified to retry the input or take other appropriate action (stage 314). The process ends at end point 316.

FIG. 6 illustrates one implementation of an exemplary interface 330 that can be implemented by a user interface (or other suitable) framework to facilitate direct synchronous input. The interface shown in FIG. 6 does not provide any implementation details, but rather defines the types of features that a framework should provide in order to monitor inputs according to some or all of the techniques described in FIGS. 2-5. In another implementation, the specific program implementation details for interface definition 330 can be provided in an application programming interface (API) instead of or in addition to an interface itself. In yet another implementation, some, all, and/or additional components are included as part of the interface and/or API.

The interface 330 has an INPUT_TYPE enumeration 332, which has various input device enumeration members, such as KEY_UP, KEY_DOWN, and so on. Interface 330 also has an interface called INotifyInputReceipt 336 that specifies methods for starting and stopping the listening for notifications. More specifically, the interface includes a StartListening method 338 and a StopListening method 340. The INotifyInputReceipt interface 336 can be implemented by a user interface framework. In one implementation, a target element is bound to the interface instance instead of being specified as a parameter. The StartListening method 338, when called, checks further input of the specified type, and when matching input is found, checks if the target element matches this element. If they do match, then the InputReceived event 342 is fired, and if they do not match, then the InputDiscarded event 344 is fired. The StopListening method 340, when called, reverts the framework back to normal operation if the framework was currently listening for input.

FIGS. 2-6 described some implementations for providing direct synchronous input for target elements by using input monitoring either directly or through a user interface framework implementation. In other implementations, target element synchronization can be provided using wait notifications. For example, in one implementation, a wait notification process can simply sleep a predetermined amount of time after input delivery fails and then attempt to send the input again. In another implementation, after an input delivery failure, the wait notification process can wait until the target application stops consuming CPU resources and is ready to receive input again before another attempt to send the input is made. As a few non-limiting examples, waiting may be necessary because CPU resources are being consumed by the target application during a form load, treeview expansion, and so on.

Turning now to FIG. 7, an illustrative example is provided that discusses the usage of some of the direct synchronous input techniques discussed herein (in FIGS. 2-6) in combination with the wait notification techniques discussed previously. The process begins at start point 450 with determining if the input that is to be sent to a target element requires waiting (decision point 452). As noted earlier, a few non-limiting examples of when waiting may be necessary can include waiting for a form to load, a treeview to be expanded, and so on. If the input requires waiting (decision point 452), then a wait notification process such as the ones described previously can be performed (stage 454). If the input does not require waiting (decision point 452), then a direct synchronous input process such as the one described in FIG. 4 can be performed (stage 456). The process ends at end point 458.

The implementations described here are technology agnostic, in that they should be able to be built into the underlying applications at a low-enough level that the implementation is invisible to users of the automatic testing programs; objects are selected without any awareness of the underlying synchronization.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
using an input monitor, determining where an input from a sender that is directed to a target element is about to be delivered, the input being intended to emulate user input to the target element programmatically; and
if the input is about to be delivered to the target element, delivering the input to the target element and notifying the sender that delivery to the target element succeeded.

2. The computer-readable medium of claim 1, further having computer-executable instructions for causing a computer to perform steps comprising:
if the input is about to be delivered to a different element than the target element, cancelling the delivery of the input and notifying the sender that delivery to the target element failed.

3. The computer-readable medium of claim 2, wherein the sender is notified that delivery to the target element failed so the sender can re-send the input to the target element.

4. The computer-readable medium of claim 1, wherein if the input has not been delivered to any element yet, then waiting a pre-defined period of time before determining that delivery to the target element failed.

5. The computer-readable medium of claim 1, wherein the input monitor uses a system message hook.

6. A method for monitoring input delivery to enhance user input emulation comprising the steps of:
turning on a monitoring mechanism for a target element;
monitoring inputs sent-to the target element; and
if a corresponding input is received by the target element from a sender that is emulating user input programmatically, notifying the sender that the corresponding input was received.

7. The method of claim 6, wherein the sender is notified by an event raised by the monitoring mechanism.

8. The method of claim 6, wherein the inputs are monitored using a system hook.

9. The method of claim 8, wherein the system hook is a get message hook.

10. The method of claim 6, wherein the target element is an HTML element, and wherein the inputs are monitored by a system hook in combination with an event handler that was inserted into the HTML element.

11. The method of claim 6, further comprising the steps of:
if the corresponding input is received by a different element than the target element, then the corresponding input is discarded.

12. The method of claim 11, wherein once the corresponding input is discarded, notifying the sender that it is safe to reissue the corresponding input that is directed to the target element to emulate user input programmatically.

13. The method of claim 6, further comprising the steps of:
if the corresponding input is not received by the target element within a pre-defined period of time, determining that the corresponding input failed to reach the target element.

14. The method of claim 6, wherein the sender is an automated testing program.

15. The method of claim 6, wherein the sender is an automated user interface assistance program.

16. A computer-readable medium having computer-executable instructions for causing a computer to perform the steps recited in claim 6.

17. An interface for providing direct synchronous input, the interface comprising:
a start method for having an input monitor begin monitoring one or more inputs being sent to one or more target elements from at least one sender; and
a received event for notifying the at least one sender when the one or more inputs were received by the one or more target elements.

18. The interface of claim 17, further comprising:
a stop method for having the input monitor stop monitoring the one or more inputs.

19. The interface of claim 17, further comprising:
a discarded event for notifying the at least one sender when the one or more inputs were not received by the one or more target elements.

20. The interface of claim 17, wherein implementation details for the interface are provided by a user interface framework.
